(19) United States
(12) Patent Application Publication
(10) Pub. No.: US 2017/0370333 A1
(43) Pub. Date: Dec. 28, 2017

(54) SYSTEM ABLE TO CHANGE CROSS-SECTIONAL AREA OF AIR INTAKE TUBE

(71) Applicant: SOUTHERN TAIWAN UNIVERSITY OF SCIENCE AND TECHNOLOGY, TAINAN (TW)

(72) Inventors: CHO YU LEE, TAINAN CITY (TW); JUI HUNG CHANG, TAINAN CITY (TW); HUAN YUAN CHEN, TAINAN CITY (TW)

(21) Appl. No.: 15/622,324

(22) Filed: Jun. 14, 2017

(30) Foreign Application Priority Data
Jun. 24, 2016 (TW) 105119819

(51) Int. Cl. F02M 35/10; F02M 35/02

(52) U.S. Cl. CPC F02M 35/10118; F02M 35/02; F02M 35/10255

(57) ABSTRACT

A system able to change a cross-sectional area of an air intake tube is provided. The system is disposed between a throttle valve and an air intake tube of an air cleaner, and includes an adjustment device, a control module, and a stepping motor. The adjustment device includes a retaining seat, a rotating disc fitted in the retaining seat, a plurality of blades disposed on the retaining seat and the rotating disc. After the control module receives signals of an engine and the throttle valve and transmits a control signal to the stepping motor, the stepping motor drives the rotating disc to pivot the blades for controlling the cross-sectional area of an opening of the air intake tube.

### FIELD OF THE INVENTION

The present invention relates to a system, and more particularly to a system disposed between a throttle valve and an air cleaner for controlling the cross-sectional area of an opening of an air intake tube.

### BACKGROUND OF THE INVENTION

In general, the matching of an air intake tube and an engine is extremely important for the design of the engine. When the engine is at a low speed, if the air inflow can be decreased, the flow rate of the air in the air intake tube can be increased to improve the inertia effect and the pulse effect. On the contrary, when the engine is at a high rotational speed, if the air inflow can be increased, the flow resistance can be reduced to enhance the air intake efficiency and the combustion efficiency of the engine. However, the current practice is to change the length of the air intake tube, or the air intake tube is provided with another passage to adjust the air inflow. But, the way only adjusts the air inflow of the engine at a high rotational speed or at a low rotational speed, unable to adjust the air inflow in response to different rotational speeds of the engine.

In order to solve the above-mentioned problems, Taiwan Patent Publication No. 545517 discloses a “self-adjusting air intake valve”, which is installed at an intake end of an air intake tube of an engine and comprises at least two fan-shaped flexible blade units. The blade units are disposed around the end of the air intake tube. One side of each blade is fixed to the air intake tube and the other is a movable part, so that an intake valve can automatically close the blades or adjust the gap between the blades according to the stop or actuation or the engine for adjusting the air inflow of the engine.

Taiwan Patent Publication No. 1306133 discloses a “method and an apparatus for controlling variable inflow between an air intake and a throttle valve”. A one-way valve having a restoring function is provided between the air intake and the throttle valve. The one-way valve can react with the throttle valve and an intake manifold to adjust the steering engine, so that the engine quickly reaches the rotational speed corresponding to each vacuum degree for natural intake, thereby changing the vacuum degree and the rotational speed of the engine.

Chinese Patent Publication No. 101358549 discloses a “blade shutter valve system”. A retaining ring, a blade operating ring and a set of blades are mounted on a valve body having a double-layer sleeve. The retaining ring and the blade operating ring are coaxially mounted. Each blade has a first connecting point connected to the blade operating ring and a second connecting point connected to the retaining ring. Thereby, the blade operating ring is driven by a power to rotate and link the brakes, such that the blades overlap each other to close the valve or the blades expand to open the valve to improve the operating efficiency of the valve. However, the valve may be completely closed during operation and cannot be used in the intake system. Accordingly, the inventor of the present invention has devoted himself based on his many years of practical experiences to solve these problems.

### SUMMARY OF THE INVENTION

In view of the problems of the prior art, that is, the length of the air intake tube is changed or the air intake tube is added with another passage, it is not possible to adjust the air inflow in response to the rotational speed of the engine.

The primary object of the present invention is to provide a system disposed between a throttle valve and an air cleaner. The system is able to change the cross-sectional area of an opening of an air intake tube, thereby adjusting the air inflow of an engine and improving the intake efficiency.

In order to achieve the aforesaid object, a system able to change a cross-sectional area of an air intake tube is provided. The system is disposed between a throttle valve and an air intake tube of an air cleaner. The air intake tube is formed with an accommodation trough therein. The system comprises an adjustment device, a control module, and a stepping motor. The adjustment device comprises a retaining seat, a rotating disc, a plurality of blades, and a plurality of locking pins. The retaining seat has a hollow annular shape and is provided with a plurality of perforations. The retaining seat is locked to the air intake tube. The rotating disc has a hollow annular shape and is provided with a plurality of through holes and a fixing groove. The rotating disc is movably fitted in an annular space of the retaining seat. The blades are annularly disposed on the retaining seat and the rotating disc to form an opening of the air intake tube. The blades each have holes corresponding to the perforations of the retaining seat and the through holes of the rotating disc. The locking pins are inserted through the holes of the blades and locked to the perforations of the retaining seat and the through holes of the rotating disc respectively so that the blades and the rotating disc can be pivoted on the retaining seat. The control module is connected with an engine and the throttle valve and able to transmit a control signal to the stepping motor after receiving a rotational speed signal of the engine and a pressure value signal of the throttle valve. The stepping motor is disposed in the accommodation trough of the air intake tube and connected to the fixing groove of the rotating disc through a connecting lever. The stepping motor is connected with the control module. After the stepping motor receives the control signal, the stepping motor drives the rotating disc to turn so that the rotating disc links the blades to control a cross-sectional area of the opening of the air intake tube to be decreased or increased.

Based on the aforesaid, the system provided in the air intake tube can use the control module to receive the rotational speed signal of the engine and the pressure value signal of the throttle valve and then transmit the control signal to the stepping motor. When the engine is at a low rotational speed, the connecting lever drives the rotating disc to link the blades to reduce the cross-sectional area of the opening of the air intake tube. When the engine is at a high rotational speed, the connecting lever drives the rotating disc to link the blades to enlarge the cross-sectional area of the opening of the air intake tube. The system in response to the required air inflow of the engine at different rotational speeds can enhance the combustion efficiency of the engine effectively.

### BRIEF DESCRIPTION OF THE DRAWINGS

FIG. 1 is a schematic view showing the assembly of the system of the present invention;

FIG. 2 is a block diagram showing the connection of the system of the present invention;

FIG. 3 is a sectional view showing the connection of the system of the present invention;

FIG. 4 is an exploded view of the adjustment device of the present invention;

FIG. 5 is a schematic view showing the reduction of the cross-sectional area; and

FIG. 6 is a schematic view showing the enlargement of the cross-sectional area.

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

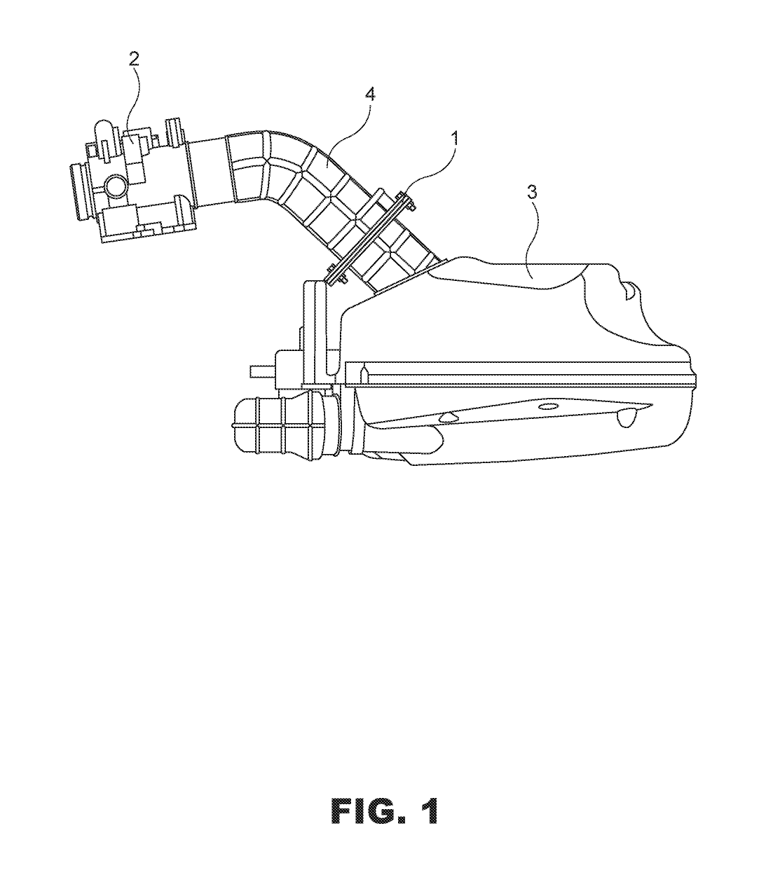

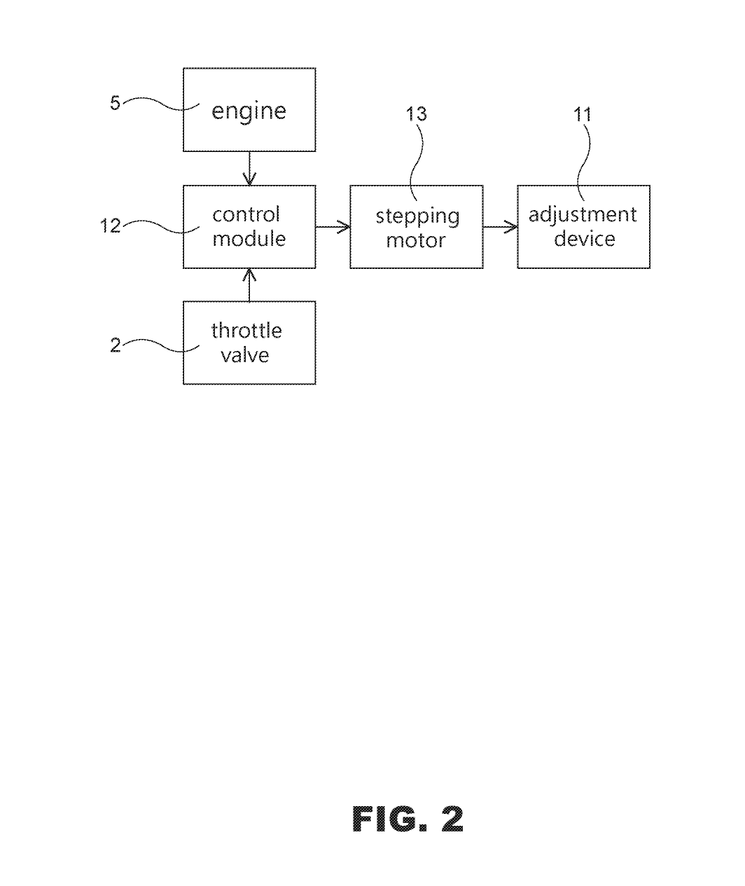

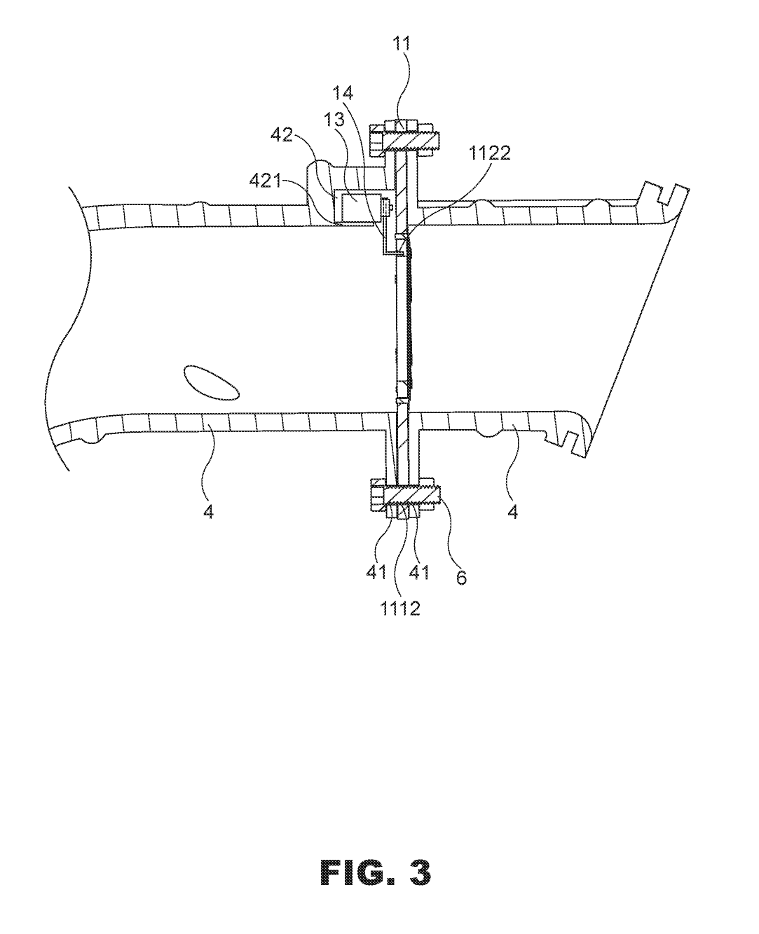

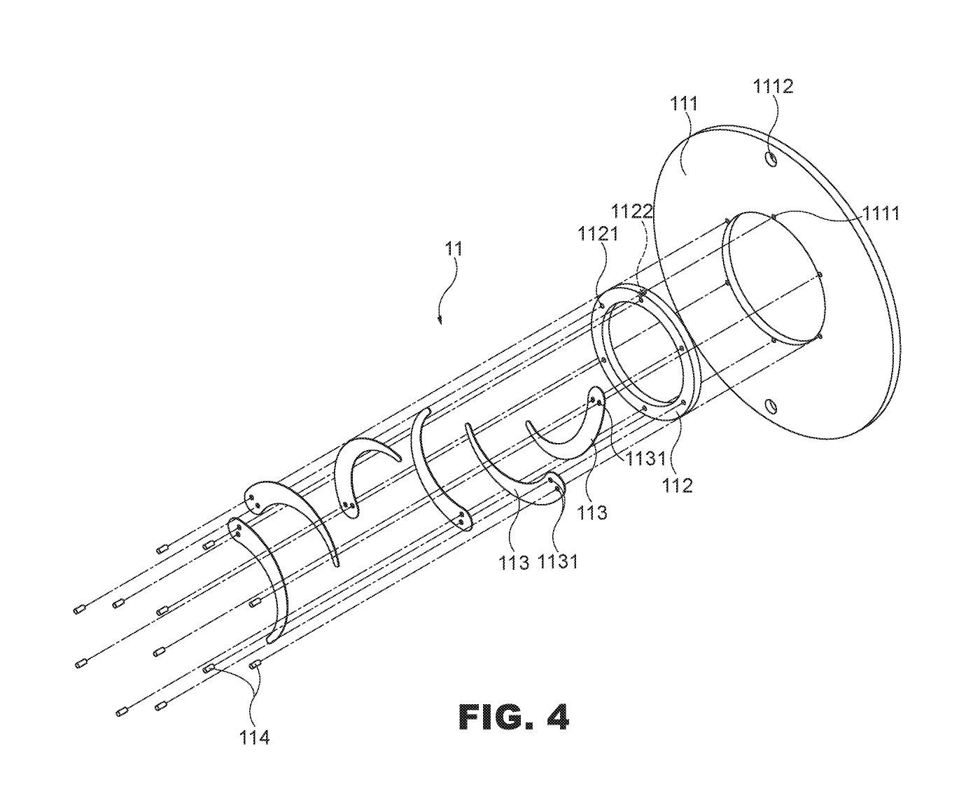

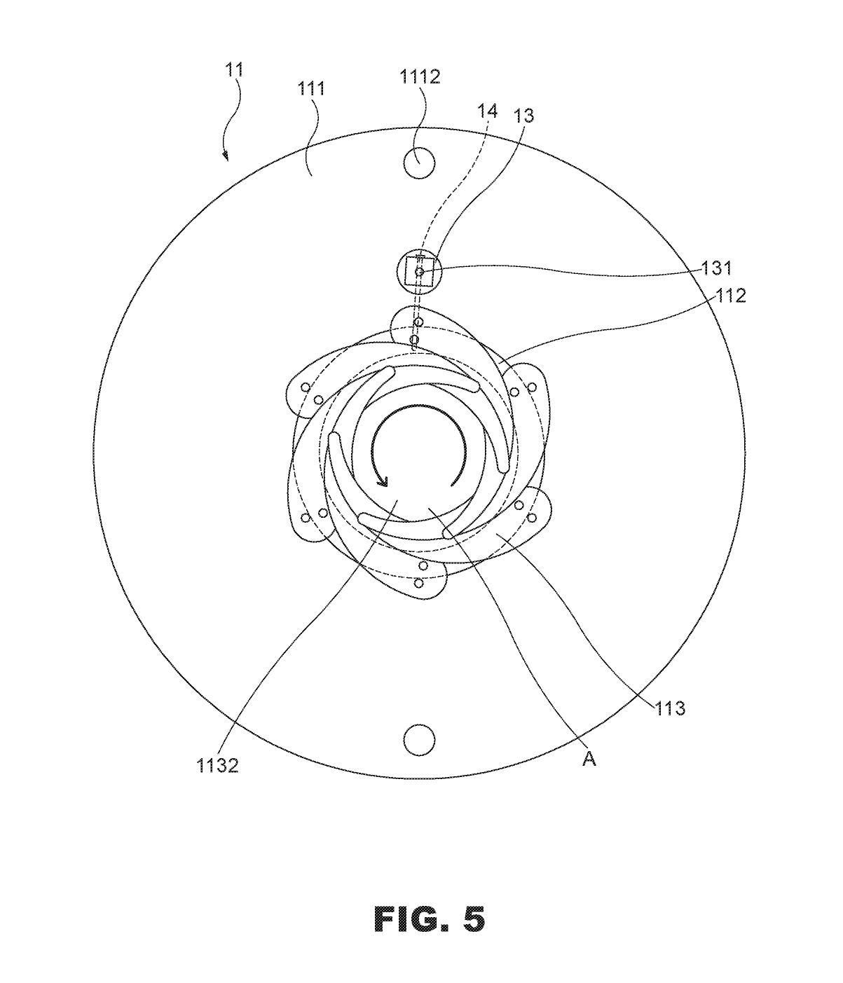

Referring to FIG. 1 and FIG. 2, the present invention discloses a system 1 able to change a cross-sectional area of an air intake tube. The system 1 is disposed between a throttle valve 2 and an air intake tube 4 of an air cleaner 3. In an embodiment of the present invention, the air intake tube 4 is a two-section tube (referring to FIG. 3). The air intake tube 4 is formed with at least two screw holes 41. One section of the air intake tube 4 is provided with an accommodation trough 421. The accommodation trough 421 is formed with an engaging wall 421 therein. The system 1 comprises an adjustment device 11, a control module 12, and a stepping motor 13. The adjustment device 11 comprises a retaining seat 111, a rotating disc 112, a plurality of blades 113, and a plurality of locking pins 114 (referring to FIG. 4). The retaining seat 111 has a hollow annular shape, and is provided with a plurality of perforations 1111 and screw holes 1112 corresponding to the screw holes 41 of the air intake tube 4. The retaining seat 111 is locked between the two sections of the air intake tube 4 through locking members 6. The rotating disc 112 has a hollow annular shape, and is provided with a plurality of through holes 1121 and a fixing groove 1122. The rotating disc 112 is movably fitted in an annular space of the retaining seat 111. The blades 113 are annularly disposed on the retaining seat 111 and the rotating disc 112 to form an opening 1132 of the air intake tube 4, referring to FIG. 5. The blades 113 each have holes 1131 corresponding to the perforations 1111 of the retaining seat 111 and the through holes 1121 of the rotating disc 112. Preferably, the blades 113 each have an arc shape. The locking pins 114 are inserted through the holes 1131 of the blades 113 and locked to the perforations 1111 of the retaining seat 111 and the through holes 1121 of the rotating disc 112, respectively, so that the blades 113 and the rotating disc 112 can be pivoted on the retaining seat 111. The control module 12 is connected with an engine 5 and the throttle valve 2. After receiving a rotational speed signal of the engine 5 and a pressure value signal of the throttle valve 2, the control module 12 transmits a control signal to the stepping motor 13. The stepping motor 13 is engaged on the engaging wall 421 of the accommodation trough 42 of the air intake tube 4 and connected to the fixing groove 1122 of the rotating disc 112 through a connecting lever 14. The stepping motor 13 is connected with the control module 12. After the stepping motor 13 receives the control signal, the rotating disc 112 is driven by the connecting lever 14 to rotate, and the blades 113 are linked by the rotating disc 12 to control the cross-sectional area of the opening 1132 of the air intake tube 4 within a restricted range.

Next, referring to FIG. 2 to FIG. 4, when in use, the system 1 is locked to the air intake tube 4, and the control module 12 is connected with the engine 5 and the throttle valve 2. When the engine 5 is at a low rotational speed, the required air inflow is small. After the control module 12 receives the rotational speed signal of the engine 5 and the pressure value signal of the throttle valve 2, the control module 12 transmits a control signal to the stepping motor 13. The stepping motor 13 has a drive shaft 131 to drive the connecting lever 14 according to the control signal, so that the rotating disc 112 of the adjustment device 11 is rotated counterclockwise in the retaining seat 111 (as shown in FIG. 5), meanwhile, the rotating disc 112 is rotated to link the blades 113 to be pivoted to reduce the cross-sectional area A of the opening 1132 of the air intake tube 4 so as to decrease the amount of air entering the throttle valve 2.

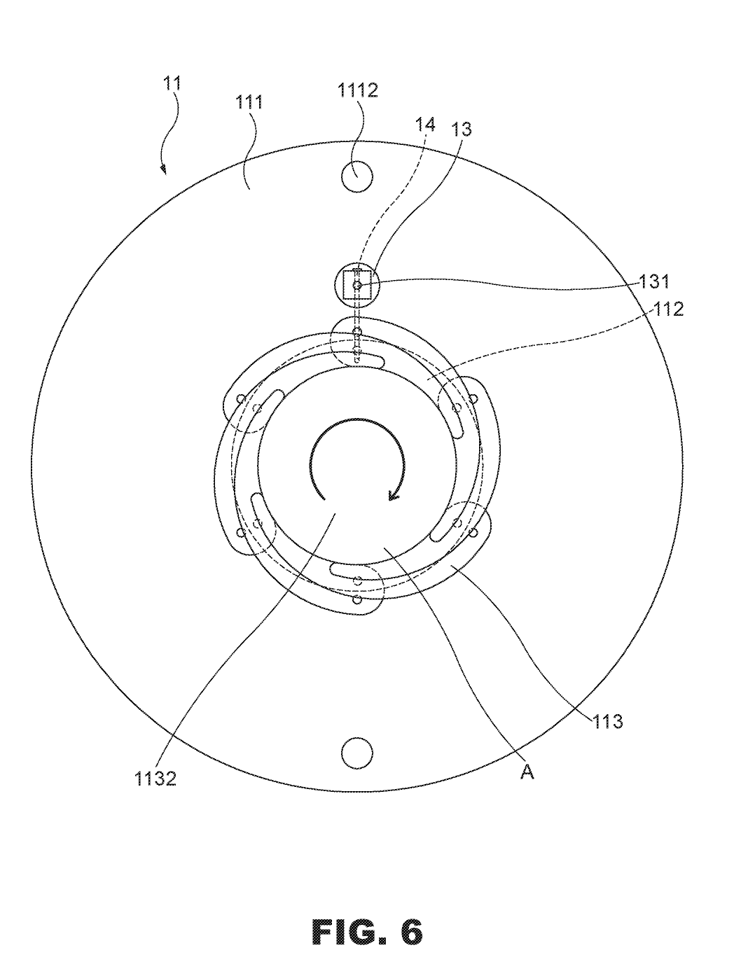

When the engine 5 is at a high rotational speed, the required air inflow is large. After the control module 12 receives the rotational speed signal of the engine 5 and the pressure value signal of the throttle valve 2, the control module 12 transmits a control signal to the stepping motor 13. The stepping motor 13 has the drive shaft 131 to drive the connecting lever 14 according to the control signal, so that the rotating disc 112 of the adjustment device 11 is rotated clockwise in the retaining seat 111 (as shown in FIG. 6), meanwhile, the rotating disc 112 is rotated to link the blades 113 to be pivoted to enlarge the cross-sectional area A of the opening 1132 of the air intake tube 4 so as to increase the amount of air entering the throttle valve 2.

Accordingly, the system of the present invention clearly achieves the following effects:

1. The system of the present invention is disposed between the throttle valve and the air intake tube of the air cleaner. After the control module receives the signals of the engine and the throttle valve, the control module controls the stepping motor to drive the rotating disc of the adjustment device to turn clockwise or counterclockwise according to the rotational speed of the engine, thereby adjusting the cross-sectional area of the air intake tube in cooperation with different rotational speeds of the engine.

2. The system of the present invention is capable of changing the cross-sectional area of the opening of the air intake tube according to the demand of the engine at different rotational speeds, thereby improving the inertia retention of the air and greatly improving the volumetric efficiency of the engine.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A system able to change a cross-sectional area of an air intake tube, the system being disposed between a throttle valve and an air intake tube of an air cleaner, the air intake tube being formed with an accommodation trough therein, the system comprising:
an adjustment device, comprising:
a retaining seat, the retaining seat having a hollow annular shape and being provided with a plurality of perforations, the retaining seat being locked to the air intake tube;
a rotating disc, the rotating disc having a hollow annular shape and being provided with a plurality of through holes and a fixing groove, the rotating disc being movably fitted in an annular space of the retaining seat;
a plurality of blades, the blades being annularly disposed on the retaining seat and the rotating disc to form an opening of the air intake tube, the blades each having holes corresponding to the perforations of the retaining seat and the through holes of the rotating disc; and
a plurality of locking pins, the locking pins being inserted through the holes of the blades and locked to the perforations of the retaining seat and the through holes of the rotating disc respectively so that the blades and the rotating disc can be pivoted on the retaining seat;
a control module, connected with an engine and the throttle valve and being able to transmit a control signal to a stepping motor after receiving a rotational speed signal of the engine and a pressure value signal of the throttle valve;
the stepping motor, disposed in the accommodation trough and connected to the fixing groove of the rotating disc through a connecting lever, the stepping motor being connected with the control module, wherein after the stepping motor receives the control signal, the stepping motor drives the rotating disc to turn so that the rotating disc links the blades to control a cross-sectional area of the opening of the air intake tube to be decreased or increased.

2. The system as claimed in claim 1, wherein the blades each have an arc shape.

3. The system as claimed in claim 1, wherein the air intake tube is a two-section tube, the air intake tube is formed with at least two screw holes, the retaining seat is provided with screw holes corresponding to the screw holes of the air intake tube, and the retaining seat is locked between two sections of the air intake tube through locking members.
